(19) United States
(12) Patent Application Publication
(10) Pub. No.: US 2007/0052676 A1
(43) Pub. Date: Mar. 8, 2007

(54) Computer input device with housing inclination mechanism

(75) Inventor: Dong-He Dai, Taipei (TW)

Correspondence Address: BACON & THOMAS, PLLC, 625 SLATERS LANE, FOURTH FLOOR, ALEXANDRIA, VA, 22314, US

(73) Assignee: KYE SYSTEMS CORP., TAIPEI (TW)

(21) Appl. No.: 11/219,678

(22) Filed: Sep. 7, 2005

(51) Int. Cl. G09G 5/08

(52) U.S. Cl. 345/163

(57) ABSTRACT

A mechanism for inclining a first housing relative to a second housing of a computer input device. The first housing has at least a support, and an axial line of the support is screwed into the lower housing. The support is inclinable relative to the lower housing at an angle sufficient to activate a corresponding micro switch within the input device.

### BACKGROUND OF THE INVENTION

1. Field of the Invention

The present invention relates to a computer input device, and in particular, to a mechanism inclining the upper housing relative to a lower housing in order to activate a switch.

2. Description of the Prior Art

Computer input devices, such as a mouse, keyboard, track ball, game controller, and so forth, have changed rapidly since the use of computers and the Internet have become common. One such change has been the addition of control tools other than the key buttons on the top or lateral sides of the input device. One such control tool, the scroll wheel or roller disclosed in U.S. Pat. No. 5,530,455, ushered in a brand new era for browsing the Internet and Windows™ based applications. Another control tool, disclosed in U.S. Pat. No. 6,700,564 and U.S. Patent Publication No. 2003/0025673, presented a new way to operate the scroll wheel or roller on the top of the mouse by laterally moving the roller.

However, the various modifications for the input device have not stopped people from pursuing further technological advancements. For example, a so-called key free mouse is disclosed in U.S. Patent Publication No. 2002/0140676. In the key free mouse, the upper housing 10 has a pin 11 at a front end and a rear end. Each of the pins 11 is received within a locking slot 21 so as to constitute a pivot axis A-A pivot axis. Once the upper housing 10 is turned about the pivot axis A-A, the upper housing 10 will activate a corresponding micro switch within the housing. However, the upper housing 10 is coupled to the lower housing 20 by engaging the pin 11 into the locking slot 21, which causes difficulties in assembling or disassembling the upper housing and the lower housing due to the fragile structure of the pin.

### SUMMARY OF THE INVENTION

It is an objective of the present invention to provide an input device having an inclinable housing, which is easy to assemble and low in cost.

To accomplish this objective, the input device of a preferred embodiment of the invention includes a first or upper housing and a second or lower housing, the upper housing having at least a support, the axial line of the support being coupled via a screw to the second or lower housing; and the support being inclinable relative to the second or lower housing at a sufficient angle to activate a corresponding micro switch within the input device.

### BRIEF DESCRIPTION OF THE DRAWINGS

FIG. 1 is an exploded isometric view of an input device constructed in accordance with the principles of a preferred embodiment of the invention.

FIG. 2A is the top view of the input device of FIG. 1.

FIG. 2B is a sectional view taken along line A-A of FIG. 2.

FIG. 2C is a sectional view taken along line H-H of FIG. 2.

FIG. 2D is yet another sectional view taken along line F-F of FIG. 2.

### DETAILED DESCRIPTION OF THE PREFERRED EMBODIMENTS

The following detailed description is of the best presently contemplated mode of carrying out the invention. This description is not to be taken in a limiting sense, but is made merely for the purpose of illustrating general principles of embodiments of the invention. The scope of the invention is best defined by the appended claims.

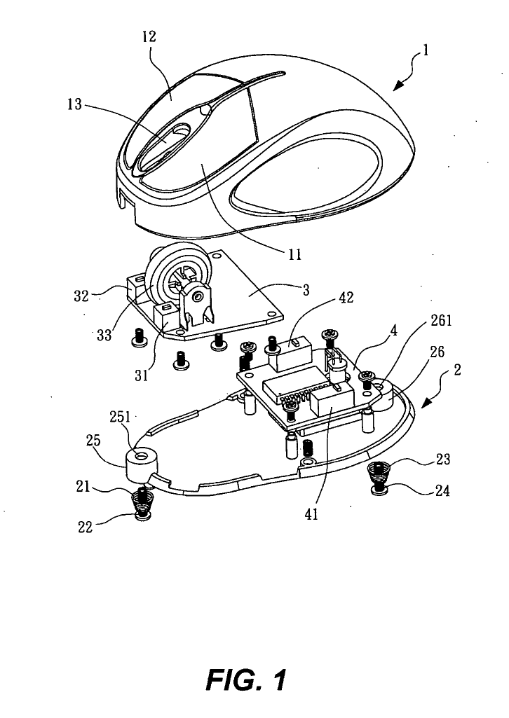

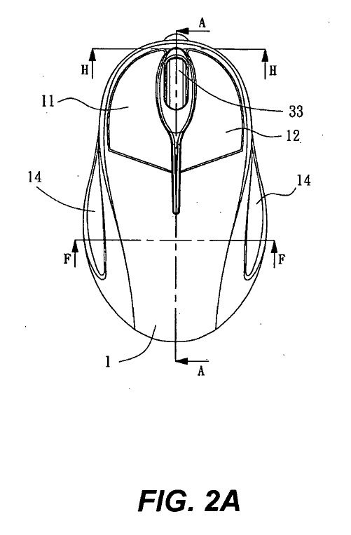

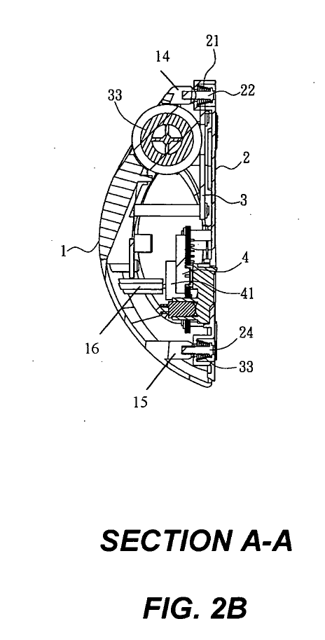

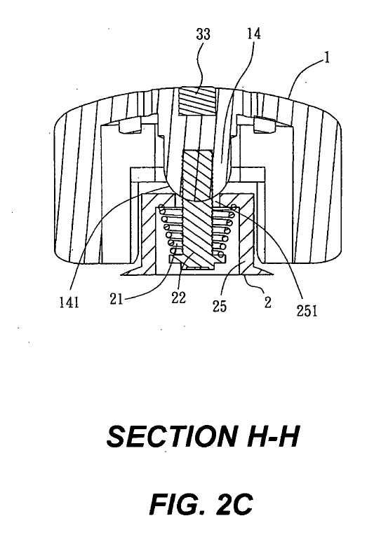

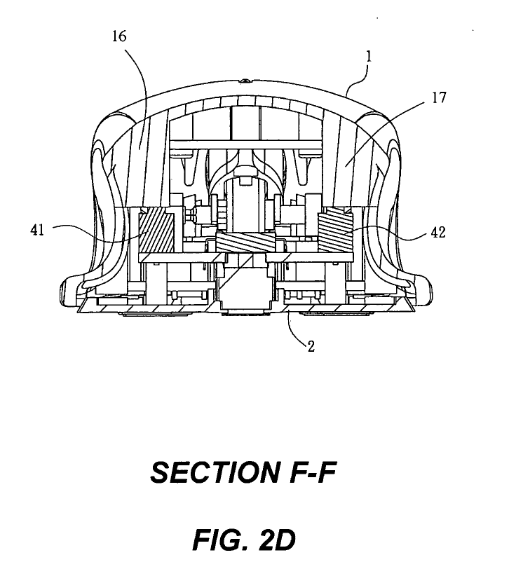

Referring to FIGS. 1˜2 D, the input device having an inclinable mechanism according to a preferred embodiment of the invention includes an upper housing 1 and a lower housing 2. The upper housing 1 has a first button 11, a second button 12, and an opening 13. The first button 11 and the second button 12 can respectively activate first micro switches 31 and 32, and the opening 13 can receive a roller 33 therein. The upper housing has supports 14, 15 (see FIGS. 2A-2C) at a front end and a rear end. Each side of the support 14 has a rib 16, 17. Each of the supports 14, 15 has a convex tip 141, 142.

The lower housing 2 has recesses 25, 26 located at positions corresponding to positions of the supports 14, 15 respectively. The ribs 15, 16 at a left side and a right side can activate corresponding third and fourth micro switches 41, 42. Each of the recesses 25, 26 can receive a corresponding spring 21, 23. The screws 22(24) penetrate the corresponding springs 21(23), extending through the openings 251(261) in the lower housing, and screwing into the recesses 25(26) so as to couple the support to the lower housing while enabling the support to move relative to the lower housing. The screws 22(24) penetrate both the recesses 25 (26) and the convex tips 141(142) by an amount sufficient to bias the screws 22(24) against the spring 21(23) and generate a tension force in the springs 21(23). This in turn causes the convex tips 141(142) to be biased against, and pivotable relative to, the opening 251 (261).

When a user exerts a left lateral force on the upper housing 1, the support 14, 15 is inclined with respect to the lower housing 2 at an angle, and the rib 16 (17) activates the corresponding micro switch 41(42). When the user removes the lateral force on the upper housing 1, the tension force generated by the spring 21 and 23 will force the convex tips 141, 142 of the supports 14, 15, which are in the openings 251, 261, to move back to a neutral position, usually a horizontal position.

A practical use of the invention is that a user may scroll a Windows™-based application up and down by rotating the roller 33, and clicking on an item by pressing the left key button 11 to run a specific program or activate a hyperlink, and the user may further incline the upper housing 1 to activate the micro switch 41(42) to scroll the window-based application left and right. The function of an activated micro switch can be designated by the firmware or software.

Those skilled in the art will appreciate that the incline of the upper housing 1 according to the present invention is a “point to point” or “point to plane” balancing-control movement (convex tip 141/142 moves in recess 25/26), and therefore contrary to the coaxial rotating movement disclosed in U.S. Patent Publication No. 2002/0140676 (pin 11 turning within the slot 21). As a result, the present invention is easy to assemble and disassemble, and the cost to produce the invention is relatively low to any known skill.

While the description above refers to particular embodiments of the present invention, it will be understood that many modifications may be made without departing from the spirit thereof. The accompanying claims are intended to cover such modifications as would fall within the true scope and spirit of the present invention.

What is claimed is:

1. An input device, comprising:
a mechanism for inclining an upper housing relative to a lower housing,
wherein the upper housing has at least one support and ribs at sides of the support; each of ribs being arranged to activate a corresponding micro switch;
wherein the support has a convex tip and the lower housing is coupled to the support by a screw that is fixed to the support and extends through an opening in the lower housing so as to be movable relative to the lower housing, the convex tip being pivotable relative to the opening such that the lower housing is inclinably coupled to the upper housing by the screw and support;
whereby the support is inclinable relative to the lower housing at an angle sufficient to cause the rib to activate the corresponding micro switch.

2. The input device as claimed in claim 1, wherein a resilient element is positioned between the screw and the lower housing.

3. The input device as claimed in claim 1, wherein the lower housing has a recess for receiving the resilient element therein, and the screw is biased against the resilient element as to generate a tension force in the resilient element.

4. The input device as claimed in claim 3, wherein the resilient element is a spring.

5. The input device as claimed in claim 3, wherein the recess has an opening and the screw penetrates the recess and the convex tip such that the convex tip is positioned on the opening.

6. The input device as claimed in claim 1, wherein the upper housing further has a first button and second button for activating a corresponding micro switch.

7. The input device as claimed in claim 1, further comprising a second said support, and wherein the first said support is located at a front end of the upper housing, and the second said support is located at a rear end of the upper housing.

8. An input device, comprising:
a first housing and a second housing;
wherein the first housing has at least a support, and an axial line of the support is screwed into the second housing;
wherein the support is inclinable relative to the second housing at an angle sufficient to activate a corresponding micro switch within the input device.

9. The input device as claimed in claim 8, wherein the second housing has a resilient element; and wherein when the support is screwed into the second housing, the resilient element applies a restoring force to the first housing to move the housing from said angle to a neutral position.
